(19) United States
(12) Patent Application Publication
(10) Pub. No.: US 2022/0285761 A1
(43) Pub. Date: Sep. 8, 2022

(54) LIQUID COOLING BATTERY MODULE

(71) Applicant: NATIONAL CHUNG SHAN INSTITUTE OF SCIENCE AND TECHNOLOGY, Taoyuan City (TW)

(72) Inventors: FU-MIN FANG, Taoyuan City (TW); CHIH-HSIEN CHUNG, Taoyuan City (TW); GWO-HUEI YOU, Taoyuan City (TW); KUO-KUANG JEN, Taoyuan City (TW)

(21) Appl. No.: 17/190,435

(22) Filed: Mar. 3, 2021

(51) Int. Cl. H01M 10/6568; H01M 10/613; H01M 50/522; H01M 50/209; H01M 10/647; H01M 50/211; H01M 10/653; H01M 50/507; H01M 50/249

(52) U.S. Cl. CPC H01M 10/6568; H01M 10/613; H01M 50/522; H01M 50/209; H01M 10/647; H01M 50/211; H01M 10/653; H01M 50/507; H01M 50/249; H01M 2220/20

(57) ABSTRACT

A liquid cooling battery module includes a collector, a cell liquid cooler, a plurality of cells, a base, an upper lid and a plurality of copper busbars. The cell liquid cooler has a plurality of multi-port extrusion tubes spaced apart equidistantly and parallelly. The collector is in communication with the multi-port extrusion tubes to thereby form a cooling liquid circulation space. The collector has therein an adaptor in communication with the cooling liquid circulation space. The cells are disposed between the multi-port extrusion tubes parallelly and alternately. The base is disposed below the cell liquid cooler. A plurality of cell positioning slots are disposed at the bottom of the base and adapted to contain the cells. The multi-port extrusion tubes serve as heat-dissipating tubes between the cells to enable the liquid cooling battery module to control temperature and attain uniform distribution of temperature quickly and effectively by liquid cooling.

### BACKGROUND OF THE INVENTION

### 1. Field of the Invention

The present disclosure relates to battery manufacturing technology, and in particular to a liquid cooling battery module for combining cells.

### 2. Description of the Related Art

Compared with diesel buses, electric buses are confronted with limitations in terms of convenience of public transport. For example, electric buses are disadvantaged by short driving range, long charging time, and short battery service life. Furthermore, battery modules account for an extremely large proportion of the cost of electric buses, and thus cost efficiency of electric buses depends on the service life of battery modules. To increase the popularity of electric buses, the current trend of development of electric buses is to develop fast charging technology and heat management technology in hopes that battery modules of electric buses will not only be recharged quickly but will also enjoy long service life.

Fast charging is associated with selection of types of cells. Long service life is associated with battery management and heat management. In the course of recharging and discharging, the increase in temperature caused by ohmic heat and chemical reaction heat in lithium-ion battery not only directly affects the cells' service life, efficiency, reliability and safety, but battery heat becomes out of control as a result of accumulation and poor management of heat. Research findings are as follows: the optimal operating temperature of lithium-ion battery ranges from 20° C. to 45° C.; and the maximum temperature difference between the cells or between modules must not be greater than 5° C. Therefore, it is necessary to provide an appropriate battery heat management system operating within a fast charging battery system.

Battery heat management systems are of three types: air cooling system, liquid cooling system, and PCM (phase change material) cooling system. The air cooling system is disadvantaged by poor cooling performance and thus fails to meet the battery cooling requirement in adverse environment or is unable to operate under heavily loaded cycling condition. The PCM-based cooling system is effective in lowering temperature and keeping the temperature difference small, but its application is restrained by the packaging and volume change during a phase change period. Therefore, liquid cooling is a better choice for the heat management system of electric vehicles, such as a battery system of an electric bus.

CN 205621819 discloses liquid cooling pipes functioning as the base of a prismatic battery, wherein underlying pipes of a larger diameter serve as the base which batteries lie on. Liquid cooling pipes of a smaller diameter are disposed between the batteries and thus space apart the batteries, respectively. The serpentine pipes is designed to increase contact area. However, the batteries are neither fastened to the liquid cooling system nor designed to come into contact therewith. Therefore, the odds are that poor heat dissipation battery might occur because of poor contact between the liquid cooling pipes.

U.S. Pat. No. 6,858,344 discloses a liquid cooling battery module, wherein a securing board 34 is produced from outside and adapted to press a battery and a cooling board inward to thereby for them to be attached firmly to each other. However, this design is likely to cause a problem: a fastening element 35 loosens because of a creep arising from a long time period of high temperature. As a result, the joint of the battery and the cooling board deteriorates gradually, leading to eventual deterioration of heat dissipation performance.

U.S. Pat. No. 6,858,344 disposes placing a metal heat dissipation board in between batteries and then placing a heat dissipation plastic pad in between the metal heat dissipation board and each battery to firmly attach them to each other. Then, the battery structure is placed on the liquid cooling board. Next, the metal heat dissipation board and the liquid cooling board are tightly joined, using the heat dissipation plastic pad. The liquid cooling pipe is not located between the batteries to achieve heat dissipation; instead, heat generated by the batteries is transferred by the metal heat dissipation board and heat dissipation plastic pad to the underlying liquid cooling board to attain heat dissipation. Excessive heat transfer interfaces are indicative of limited heat dissipation performance.

U.S. Pat. No. 9,923,251 discloses liquid cooling tubes adapted for cylindrical cells and adapted to work by contact heat dissipation. The liquid cooling tubes (209, 301) achieve heat dissipation by being in contact with the bottom surfaces of the cylindrical cells or the lateral surfaces of the cylindrical cells. Owing to the limitative effect of the geometrical shapes of the surfaces of the cylindrical cells, the liquid cooling tubes enclose the lateral surfaces of the cells. As a result, their contact area is disadvantageously confined to corners of the cylindrical surfaces or even only a straight line, not to mention limited contact surface area and poor heat dissipation performance.

### BRIEF SUMMARY OF THE INVENTION

An objective of the present disclosure is to provide a liquid cooling battery module, wherein multi-port extrusion tubes (MPET) function as heat dissipation tubes disposed between cells and adapted to dissipate heat by liquid cooling, so as to achieve battery module fast charging, control temperature, and attain uniform distribution of temperature quickly and effectively by liquid cooling.

To achieve at least the above objective, the present disclosure provides a liquid cooling battery module, comprising: a collector; a cell liquid cooler having a plurality of multi-port extrusion tubes spaced apart equidistantly and parallelly, the multi-port extrusion tubes each being connected to a first end of the collector, the collector being in communication with the multi-port extrusion tubes to thereby form a cooling liquid circulation space, wherein an adaptor is disposed at a second end of the collector, the second end being opposite the first end, the adaptor being in communication with the cooling liquid circulation space; a plurality of cells disposed between the multi-port extrusion tubes parallelly and alternately; a base disposed below the cell liquid cooler, wherein a plurality of cell positioning slots are disposed at a bottom of the base and adapted to contain the cells; an upper lid disposed above the cell liquid cooler; and a plurality of copper busbars disposed above the upper lid to electrically connect the cells in series and in parallel.

In an embodiment of the present disclosure, the cooling liquid circulating within the cooling liquid circulation space is deionized water, a mixture of deionized water and ethylene glycol (50%/50%), or a mixture of deionized water and propylene glycol (60%/40%).

In an embodiment of the present disclosure, the cells are prismatic or pouch cells.

In an embodiment of the present disclosure, the cells are spaced apart from the multi-port extrusion tubes by a distance, and the distance ranges from 0.3 to 1.0 mm.

In an embodiment of the present disclosure, the base has a plurality of support posts for preventing the upper lid from pressing against the cells and the multi-port extrusion tubes.

In an embodiment of the present disclosure, the upper lid has a plurality of thermal paste injection apertures whereby thermal paste is injected into the liquid cooling battery module.

In an embodiment of the present disclosure, the liquid cooling battery module is in a plural number and stacked up.

In an embodiment of the present disclosure, the liquid cooling battery module further comprises at least one diverting strip which connects the stacked liquid cooling battery modules to the adaptors, respectively.

In an embodiment of the present disclosure, the liquid cooling battery module further comprises a soft copper busbar for connecting the copper busbars of the stacked liquid cooling battery modules.

In an embodiment of the present disclosure, cross sections of the multi-port extrusion tubes are polygons and concave polygons.

### BRIEF DESCRIPTION OF THE DRAWINGS

FIG. 1A is an isometric view of multi-port extrusion tubes according to an embodiment of the present disclosure.

FIG. 1B is a cross-sectional view of the multi-port extrusion tubes according to an embodiment of the present disclosure.

FIG. 2 is a perspective view of a cell liquid cooler according to an embodiment of the present disclosure.

FIG. 3 is an exploded view of the cell liquid cooler according to an embodiment of the present disclosure.

FIG. 4 is a perspective view of a base according to an embodiment of the present disclosure.

FIG. 5 is a schematic view of a liquid cooling battery module assembled according to an embodiment of the present disclosure.

FIG. 6 is an exploded view of the liquid cooling battery module according to an embodiment of the present disclosure.

FIG. 7 is a schematic view of two layers of the liquid cooling battery module.

FIG. 8 is an exploded view of two layers of the liquid cooling battery module.

### DETAILED DESCRIPTION OF THE INVENTION

To facilitate understanding of the object, characteristics and effects of this present disclosure, embodiments together with the attached drawings for the detailed description of the present disclosure are provided.

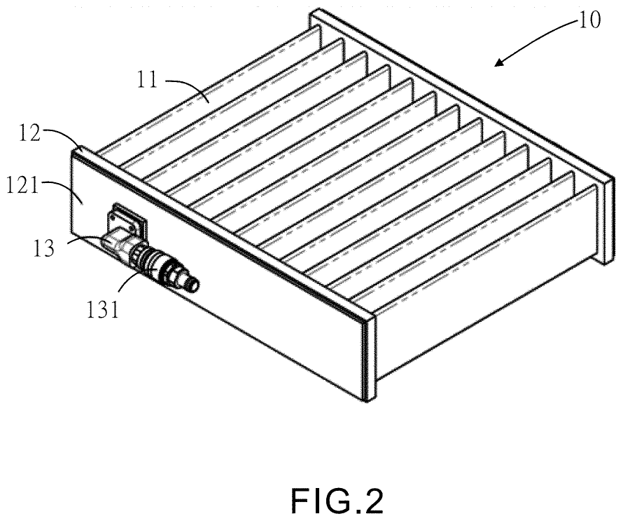

Referring to FIGS. 2-6, the present disclosure provides a liquid cooling battery module 1 comprising a collector 12, a cell liquid cooler 10, a plurality of cells 4, a base 20, an upper lid 30 and a plurality of copper busbars 31.

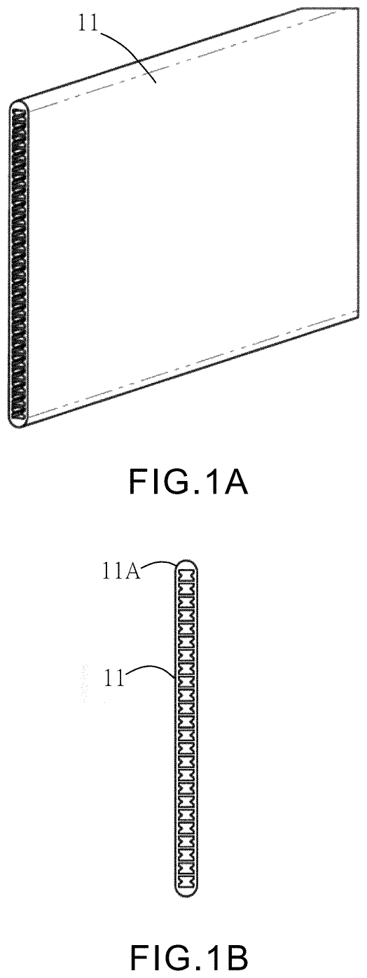

Referring to FIG. 2, the cell liquid cooler 10 has a plurality of multi-port extrusion tubes 11 spaced apart equidistantly and parallelly. According to the present disclosure, multi-port aluminum extrusion tubes serve as heat-dissipating tubes between the cells and are widely applied to conventional radiators and heat exchangers, as aluminum pipeline welding processes are well-developed. Referring to FIG. 1A and FIG. 1B, according to the present disclosure, the multi-port extrusion tubes 11 are planar, suitable for operating in conjunction with prismatic or pouch cells 4 to effectuate liquid cooling, and effective in dissipating heat when aligned with geometrically-shaped surfaces of the cells 4 in a plane-to-plane manner without undergoing any bending process. The cross sections 11A of the multi-port extrusion tubes 11 can be of any geometrical shapes, such as polygons and concave polygons, provided that the contact area between the liquid and metal tube is maximized. The multi-port extrusion tubes 11 penetrate the collector 12, and the junctions thereof are highly watertight. The high degree of watertightness is achieved by a welding process carried out from within the collector 12. The welding process is that of laser welding, fusion welding, brazing or soldering.

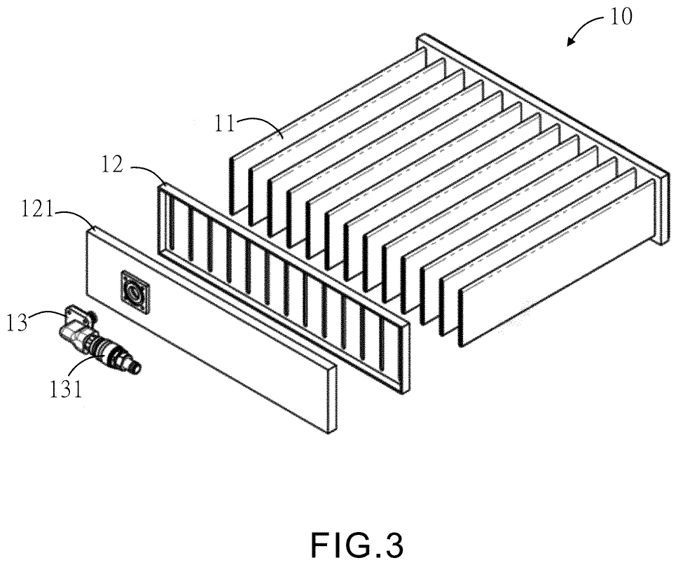

Referring to FIG. 2, the multi-port extrusion tubes 11 are spaced apart by the same spacing as used to space apart the cells in order for the multi-port extrusion tubes 11 to form the cell liquid cooler 10. The multi-port extrusion tubes 11 are connected in parallel and to a first end of the collector 12. The collector 12 is in communication with the multi-port extrusion tubes 11 to form a cooling liquid circulation space. An adaptor 13 is disposed at a second end of the collector 12. The second end of the collector 12 is opposite the first end of the collector 12. The adaptor 13 and the cooling liquid circulation space are in communication with each other. The adaptor 13 not only communicates with tubes but also outputs or inputs the cooling liquid which has undergone heat exchange. Referring to FIG. 3, the collector 12 further comprises a collector cover 121. The adaptor 13 is disposed at the collector cover 121. Disposed at the other end of the adaptor 13 is a tube connector or a quick-release connector 131 whereby maintenance workers conveniently and quickly change connector interfaces of modularized liquid cooling tubes for maintenance.

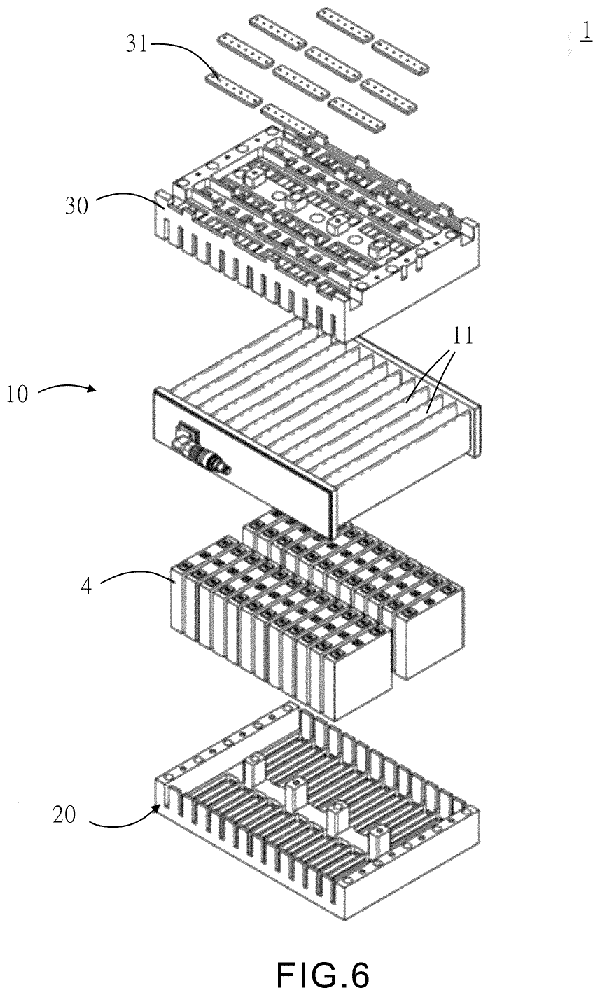

Referring to FIG. 6, the cells 4 are disposed between the multi-port extrusion tubes 11 parallelly and alternately.

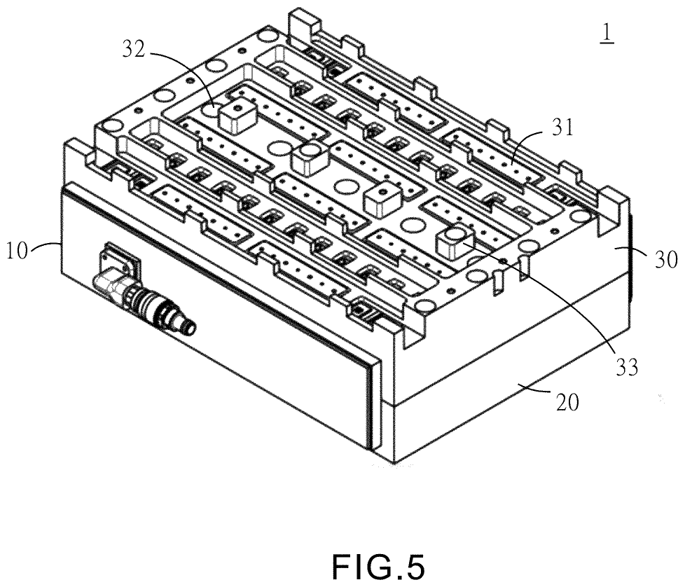

Referring to FIG. 5 and FIG. 6, the upper lid 30 is disposed above the cell liquid cooler 10, and the copper busbars 31 are disposed above the upper lid 30. The copper busbars 31 penetrate the upper lid 30 and thus electrically connect to the cells 4.

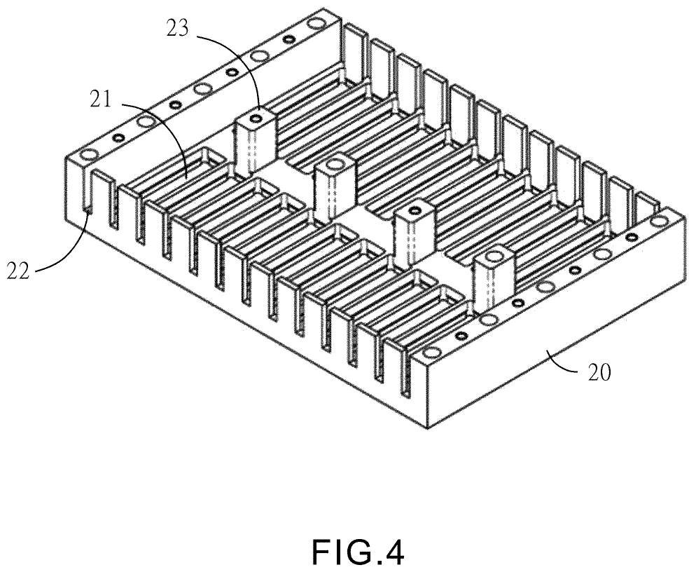

Referring to FIG. 4 and FIG. 6, the base 20 is disposed below the cell liquid cooler 10. A plurality of cell positioning slots 21 are disposed at the bottom of the base 20 and adapted to contain the cells 4. A plurality of positioning slots 22 are disposed at the base 20 laterally and penetrable by the multi-port extrusion tubes 11. The base 20 has a plurality of support posts 23. The support posts 23 protect the cells 4 and the multi-port extrusion tubes 11 against damage caused by twists and deformations. Furthermore, the cells 4 are not directly attached to the multi-port extrusion tubes 11 by pressure-induced tightening. In other words, there are gaps (space) between the cells 4 and the multi-port extrusion tubes 11.

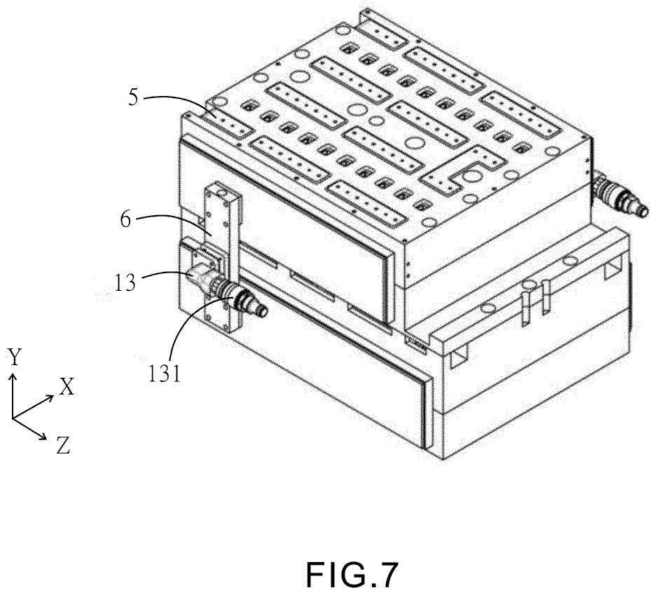

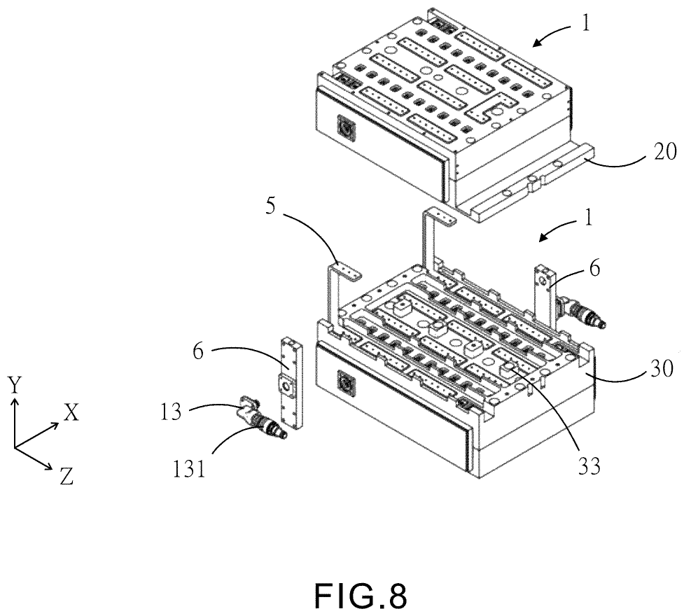

Referring to FIG. 5 and FIG. 6, after the cells 4 and the cell liquid cooler 10 have been mounted on the base 20, the upper lid 30 is mounted in place, and the copper busbars 31 are electrically connected to the cells 4 in series and in parallel, so as to form the liquid cooling battery module 1. The upper lid 30 has a plurality of thermal paste injection apertures 32 whereby thermal paste is injected into the liquid cooling battery module 1. Gaps (space) between the cells 4 and the multi-port extrusion tubes 11 can be filled with the injected thermal paste (not shown), so as to form heat transfer paths for the heat of the cells 4 to be transferred to the multi-port extrusion tubes 11 and ultimately dissipated with the cooling liquid. The width of the gaps ranges from 0.3 to 1.0 mm and is preferably 0.7 mm. Referring to FIG. 6, the upper lid 30 is fastened to the base 20 with screws (not shown). The upper lid 30 has external support posts 33. Referring to FIG. 7 and FIG. 8, when at least two layers of said liquid cooling battery module 1 are stacked up, the external support posts 33 prevent the cells 4 from being subjected to gravity-induced compression. The upper lid 30 and the base 20 bear the compression force. The upper lid 30 and the base 20 are made of polyoxymethylene (POM).

In an embodiment of the present disclosure, to increase capacitance or voltage of the liquid cooling battery module 1 despite inadequate space on XZ-plane, two or more layers of the liquid cooling battery module 1 are stacked up in direction Y, and the upper and lower layers are not necessarily equal in the number of the cells. FIG. 7 is a schematic view of two layers of the liquid cooling battery module 1. FIG. 8 is an exploded view of two layers of the liquid cooling battery module 1. The copper busbars 31 of the upper and lower layers of the liquid cooling battery module 1 are connected by soft copper busbars 5 or other flexible conducting wires to electrically connect the upper and lower layers of cells 4 of the liquid cooling battery module 1 in series and in parallel. The soft copper busbars 5 demonstrate flexibility and thus facilitate connection of the upper and lower layers of the liquid cooling battery module 1.

The liquid cooling battery module 1 further comprises at least one diverting strip 6. The respective adaptors 13 for the upper and lower layers of the liquid cooling battery module 1 are connected by the at least one diverting strip 6. The diverting strip 6 serves as a cooling tube parallel-connection framework of the upper and lower layers of the liquid cooling battery module 1. The diverting strip 6 connects the cell liquid coolers 10 (cooling liquid circulation space) of the upper and lower layers of the liquid cooling battery module 1. After both their cooling liquids have met, the adaptors 13 output or input the cooling liquids which have undergone heat exchange.

Therefore, the present disclosure provides a liquid cooling battery module 1 comprising cells between which heat-dissipating tubes are disposed and adapted to control temperature and attain uniform distribution of temperature quickly and effectively by liquid cooling. The heat-dissipating tubes are multi-port extrusion tubes. The multi-port extrusion tubes are provided in the form of multi-port aluminum extrusion tubes. According to the present disclosure, the multi-port extrusion tubes are planar liquid cooling tubes suitable for use with prismatic LTO (lithium titanium oxide) cells or pouch cells. Furthermore, according to the present disclosure, the multi-port extrusion tubes are effective in dissipating heat when aligned with geometrically-shaped surfaces of the cells in a plane-to-plane manner without undergoing any bending process. Also, the present disclosure is advantageous in that the multi-port extrusion tubes can be applicable to prismatic cells of any dimensions by altering the spacing, length or width of the multi-port extrusion tubes, so as to meet the strict heat dissipation requirement of fast charging battery modules. Therefore, liquid cooling enables large battery modules of electric buses to not only be recharged quickly but also enjoy long service life.

In this embodiment, the cooling liquid circulating within the cooling liquid circulation space is deionized water, a mixture of deionized water and ethylene glycol (50%/50%), or a mixture of deionized water and propylene glycol (60%/40%).

In this embodiment, the cells 4 are prismatic or pouch cells.

While the present disclosure has been described by means of specific embodiments, numerous modifications and variations could be made thereto by those skilled in the art without departing from the scope and spirit of the present disclosure set forth in the claims.

What is claimed is:

1. A liquid cooling battery module, comprising:
a collector;
a cell liquid cooler having a plurality of multi-port extrusion tubes spaced apart equidistantly and parallelly, the multi-port extrusion tubes each being connected to a first end of the collector, the collector being in communication with the multi-port extrusion tubes to thereby form a cooling liquid circulation space, wherein an adaptor is disposed at a second end of the collector, the second end being opposite the first end, the adaptor being in communication with the cooling liquid circulation space;
a plurality of cells disposed between the multi-port extrusion tubes parallelly and alternately;
a base disposed below the cell liquid cooler, wherein a plurality of cell positioning slots are disposed at a bottom of the base and adapted to contain the cells;
an upper lid disposed above the cell liquid cooler; and
a plurality of copper busbars disposed above the upper lid to electrically connect the cells in series and in parallel.

2. The liquid cooling battery module of claim 1, wherein the cooling liquid circulating within the cooling liquid circulation space is deionized water, a mixture of deionized water and ethylene glycol (50%/50%), or a mixture of deionized water and propylene glycol (60%/40%).

3. The liquid cooling battery module of claim 1, wherein the cells are prismatic or pouch cells.

4. The liquid cooling battery module of claim 1, wherein the cells are spaced apart from the multi-port extrusion tubes by a distance, and the distance ranges from 0.3 to 1.0 mm.

5. The liquid cooling battery module of claim 1, wherein the base has a plurality of support posts for preventing the upper lid from pressing against the cells and the multi-port extrusion tubes.

6. The liquid cooling battery module of claim 1, wherein the upper lid has a plurality of thermal paste injection apertures whereby thermal paste is injected into the liquid cooling battery module.

7. The liquid cooling battery module of claim 1, wherein the liquid cooling battery module is in a plural number and stacked up.

8. The liquid cooling battery module of claim 7, further comprising at least one diverting strip which connects the stacked liquid cooling battery modules to the adaptors, respectively.

9. The liquid cooling battery module of claim 7, further comprising a soft copper busbar for connecting the copper busbars of the stacked liquid cooling battery modules.

10. The liquid cooling battery module of claim 1, wherein cross sections of the multi-port extrusion tubes are polygons and concave polygons.
